(19) United States
(12) Patent Application Publication
(10) Pub. No.: US 2021/0374644 A1
(43) Pub. Date: Dec. 2, 2021

(54) EQUIPMENT LIFETIME PREDICTION BASED ON THE TOTAL COST OF OWNERSHIP

(71) Applicant: Saudi Arabian Oil Company, Dhahran (SA)

(72) Inventors: Ali Alsultan, Dammam (SA); Murtadha Aljubran, Dammam (SA); Amjad Alharbi, Dhahran (SA)

(21) Appl. No.: 16/889,336

(22) Filed: Jun. 1, 2020

(51) Int. Cl. G06Q 10/06; G06Q 10/00; G06Q 30/02; G06Q 10/04; G06N 7/00; G06F 3/0482

(52) U.S. Cl. CPC G06Q 10/06375; G06Q 10/20; G06F 3/0482; G06Q 10/04; G06N 7/00; G06Q 30/0283

(57) ABSTRACT

Systems and methods include a computer-implemented method for predicting equipment lifetime based on the total cost of ownership. Historical data is received that includes maintenance costs of equipment of different equipment types. The historical data is used to generate, for each equipment type, total maintenance costs that are expected to be accumulated over a lifetime for all instances of the equipment type. An average cumulative cost of a particular equipment type is determined by dividing the total maintenance costs by a number of instances of the particular equipment type that were active at a particular age. A linear regression model is generated for a particular instance of the particular equipment type. The average cumulative cost for the particular equipment type is fitted to the linear regression model. An average lifetime of the particular instance of the particular equipment type is determined based on the linear regression model.

### BACKGROUND

The present disclosure applies to predictive modeling used in estimating the lifetime of equipment, including determining the cost of equipment over time, factoring in cumulative maintenance cost, and making decisions regarding replacement of the equipment.

Predicting the occurrence of an event has long been an interest in various fields of science. Forecasting that is used in weather and financial markets are examples in which different systems and models can be developed and used. Information that can result from accurate forecasting systems can be valuable for making decisions and taking actions at appropriate times, which can save money, improve health, and provide other potential benefits. In some cases, predictive analytics has been used to predict and forecast unknown conditions of equipment, focusing on equipment failure. Predictors that have been used in such models can vary depending on targeted unknown factors and the nature of equipment.

### SUMMARY

The present disclosure describes techniques for using the total cost of ownership (TCO) to predict the best time to replace equipment based on equipment lifetime predictions. In some implementations, a computer-implemented method includes the following. Historical data is received that includes maintenance costs of equipment of different equipment types. The historical data is used to generate, for each equipment type, total maintenance costs that are expected to be accumulated over a lifetime for all instances of the equipment type. An average cumulative cost of a particular equipment type is determined by dividing the total maintenance costs by a number of instances of the particular equipment type that were active at a particular age. A linear regression model is generated for a particular instance of the particular equipment type. The average cumulative cost for the particular equipment type is fitted to the linear regression model. An average lifetime of the particular instance of the particular equipment type is determined based on the linear regression model.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, the total cost of ownership can be used as an indicator for building a strategy to determine the best course of action for maintaining equipment. Second, an entity, such as an oil company, can benefit from using predictive analytics in optimizing its operations and equipment maintenance strategy. For example, a predictive system can be used to track and optimize the management of maintenance costs. Third, corporate maintenance services departments can use TCO techniques in their equipment maintenance and replacement programs and strategies. For example, analysts can forecast the demand for equipment replacement by estimating the expected lifetime of equipment and optimized replacement schedule (for example, based on increasing estimated costs). Fourth, techniques can be used to predict the age that minimizes the TCO for plant equipment. Fifth, an overall methodology for building predictive models for equipment replacement can rely on techniques such as linear regression. Sixth, techniques can be used for predicting the lifetime (referred to as beyond economic repair) of equipment based on the cumulative maintenance cost. In this way, by using the maintenance cost records for a type of equipment, the system can predict the age of equipment when replacement should be considered and planned for, instead of continuing with maintenance plan.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a graph showing an example of a comparison between predicted versus actual cumulative equipment costs, according to some implementations of the present disclosure.

FIGS. 2A-2B collectively show a screen print of an example of a graphical user interface (GUI) for presenting cost information, according to some implementations of the present disclosure.

FIG. 3 is a flowchart of an example of a method for determining the average lifetime of a particular instance of a particular equipment type, according to some implementations of the present disclosure.

FIG. 4 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for using the total cost of ownership (TCO) to predict the best time to replace equipment based on equipment lifetime predictions. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Embodiments of the present disclosure describe techniques and systems for predicting an optimized replacement schedule for equipment by utilizing the total cost of ownership (TCO) and the equipment's expected lifetime. An optimized replacement schedule can refer to achieving cumulative cost values for equipment that indicate or result in cost savings, where the cost savings are achieved by replacing equipment rather than paying for increased equipment maintenance and repair costs. For example, the optimized replacement schedule can include making decisions that achieve cost savings that are greater than a predefined threshold.

Using historical data, a system can build a predictive model of the average cumulative cost of active equipment to estimate the maintenance cost incurred over time. The estimate can include, for example, a time-based estimate indicating an optimized replacement time for each piece of equipment. By adding the acquisition value, the system can provide an estimate of an optimal age of the equipment after which equipment repair increases significantly. This optimal age of equipment can be utilized to plan an equipment replacement strategy which can be used to save costs and enable decision makers to make better-informed decisions. Such strategies can be used, for example, in industries such as oil and gas, transportation, energy/power, manufacturing, and fleet services.

Plant maintenance is another domain in which predictive systems can be used. For example, predicting the failure of equipment can be a typical use case. Predicting such failures can help in creating a better preventive maintenance strategy to optimize equipment operations, reduce costs, and improve equipment availability.

The health sector is another domain in which predictive systems can be used to add significant value. For example, predicting conditions and correlations associated with the spread or occurrence of diseases (for example, diabetes) can help practitioners to design preventive measures and treatments. Predicting the failure of a pancreas (for example, with a high accuracy) can provide the opportunity to avoid reaching situations of advanced states of failure, allowing the pancreas to be saved.

The predictive systems and techniques described in the present disclosure can be used, in general, in any forecasting systems in which the interest is mainly to predict at what time, during the lifespan of the system, an event will occur. The predictive systems and techniques can include regression predictive models that are used for determining an optimum value based on the defined objective of the system.

The predictive systems can relate, generally, to advanced analytics, and specifically to predictive analytics. The predictive systems can be used for predicting the optimal lifetime, also referred to as beyond economic repair, of a type of equipment. The techniques can be based on the average cumulative cost for a group of equipment as well as the equipment acquisition value (or replacement cost).

In some implementations, techniques used in the current disclosure can be data-driven. For example, the techniques can use existing historical maintenance records (of similar equipment, for example) in order to find the optimal equipment lifetime.

The system can be used by users including, for example, individuals, organizations, associations, and any entity that provides activities or services related to predictive analytics. Predictive analytics refers to the use of machine learning and applied statistics to predict unknown variables based on available data. Classification and regression are two general domains that are used under predictive analytics. The term total cost of ownership (TCO) of equipment can include all costs incurred, including acquisition values, and maintenance costs.

Some conventional predictive modeling approaches use standard machine learning algorithms (such as linear regression, logistic regression, and random forests) to predict when equipment is likely to fail and become useless to end users. However, such conventional approaches do not consider the total cost of ownership. As a result, conventional approaches do not include ways to justify equipment replacement at earlier stages in order to minimize overall equipment costs over time.

Value propositions for equipment can be based on optimizing the lifetime of equipment and reducing the total cost of ownership. In some implementations, techniques can include the following steps.

A baseline process can consider the lifetime of a piece of equipment to be a time at which the cumulative maintenance costs of the equipment exceed the equipment's acquisition/replacement cost. In a baseline process, the cost c(t) at time t can be given by a formula in Equation (1):

c(t)=ae^{st} (1)

where a is a coefficient and s is a parameter.

The condition in Equation (1) can be equated to the condition in Equation (2):

c(t)=b (2)

where b is the baseline. Using Equations (1) and (2), an equivalent condition can be given by Equation (3):

$$t = \frac{1}{s} log \frac{b}{a} \qquad ( 3 )$$

Plugging this into the expression for ƒ(t), the total cost of ownership divided by the number of years y in the baseline method is given in Equation (4):

$$y = \frac{2 b}{\frac{1}{s} log \frac{b}{a}} \qquad ( 4 )$$

As a result, techniques of the present disclosure can find t(age) that minimizes ƒ(t) in

$$f ( t ) = \frac{b + c ( t )}{t} .$$

This equation models the relationship between the TCO as it relates to the equipment acquisition value and average cumulative cost c(t). The average cumulative cost can be modeled as an exponential regression function c(t)=a*e^{st}, which can be reduced to a linear regression problem that can be efficiently solved to find the parameters a and s.

Using comparisons of costs associated with both strategies made for each particular category of equipment, an optimal strategy can result in cost savings of about 5-6%, for example. Similar results can be obtained for different types of equipment.

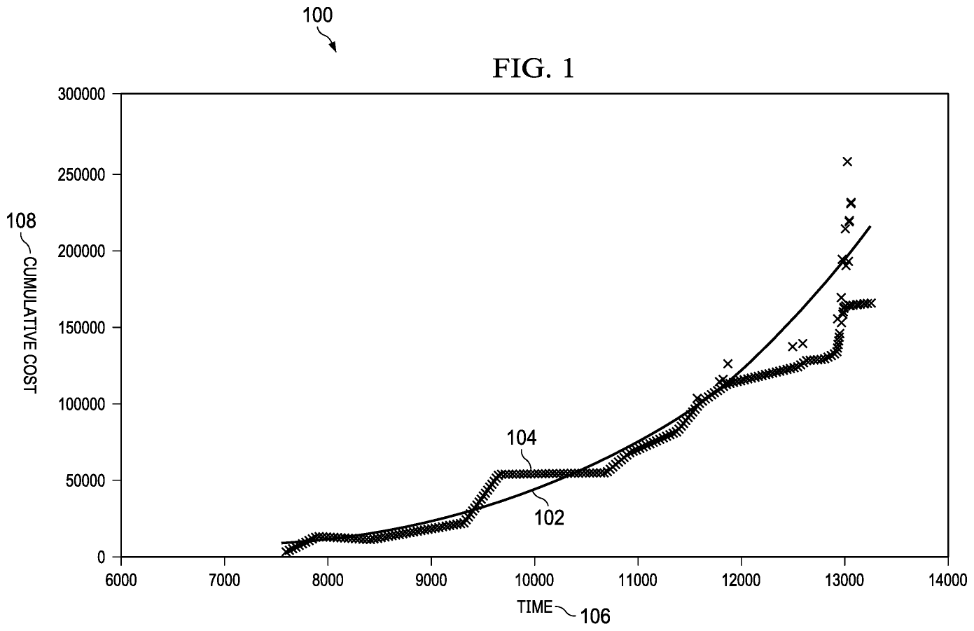

FIG. 1 is a graph 100 showing an example of a comparison between predicted versus actual cumulative equipment costs, according to some implementations of the present disclosure. The graph 100 includes a predicted average cumulative cost curve 102 and an actual cumulative cost curve 104. The curves 102 and 104 are plotted relative to a time axis 106 (for example, in days) and a cumulative cost axis 108 (for example, in dollars).

The historical data used in model development can be based on transactional data where maintenance costs have been recorded. The data will extend (or be time-shifted) from the startup date of the equipment and until the last maintenance record or known operational date.

Techniques of the present disclosure can be used to develop an analytical model for determining the lifetime of equipment. The techniques can be used to group equipment by certain fields (for example, equipment type) and to build a regression model for the total maintenance that is expected to be accumulated over the lifetime of the equipment. Such a regression model and acquisition value of the equipment can then be combined to optimize the total cost of ownership (TCO).

The cumulative cost per one instance in a group of equipment can be calculated based on the startup date (or the date of the first maintenance record if the startup date is unknown). The cumulative costs can extends until the last operational date of the equipment (or the date of the last maintenance record if the equipment status is unknown). After the last operational date, the accumulation process can ignore the equipment completely from the calculation, as there is no assumption can be made about the equipment state beyond the last known operational date.

The dates in the maintenance records can be standardized among the group of equipment by converting them into t (age), which can be calculated as age=current_date−startup_date. As a result, the cumulative costs from equipment instances can be used to calculate the average cost per age by the equation avg_cost(t)=cum_cost(t)/cum_cnt(t), where cum_cost(t) is the cumulative cost for all active equipment in a group at a given t (age), and cum_cnt(t) is the number of active equipment at a given age t.

The average cost (as age increases) can be expected to grow fast. This relationship can be estimated by assuming an exponential model as a suitable fit of the data of the form c(t)=a*e^{st}, for some unknown coefficient α and parameter s. Using the logarithm produces log c(t)=log a+s*t. Hence, the logarithm of the average cumulative maintenance cost can be fitted using linear regression.

The linear regression model can have an analytical solution that is solved efficiently to provide the parameters a and s. FIG. 1 shows an example of data for a group of equipment where the y-axis is the average cumulative cost in United States dollars (USD), and the x-axis is the age of equipment, in days. Points on the curve 104 represent the actual data from the historical maintenance records, while points on the curve 102 provide the best-fitting exponential function after solving for c(t).

If b is assumed to be the equipment acquisition value (for example, in USD), then the average TCO can be given by

$$f ( t ) = \frac{b + c ( t )}{t} .$$

In this equation, ƒ(t) encodes the cost of the equipment which decays with time t. However, the average cumulative cost can grow much faster, making equipment replacement a better approach as c(t) increases to greater values.

The optimal lifetime of the equipment is the value of t that minimizes the function ƒ(t). This can be determined by computing ƒ(t) for different choices of the lifetime (for example, an age ranging from 1 to 50 years). The age that minimizes ƒ(t) is the optimal lifetime. Note that c(t) is a predictive (regression) model, and ƒ(t) is a convex function for t>0.

In some implementations, the output generated by the system can be presented to the user in the form of a graph with a table that includes the age, actual average cumulative cost, and predicted average cumulative cost. The optimal lifetime can also be presented by inspecting the age value between 1 and 50,000 days.

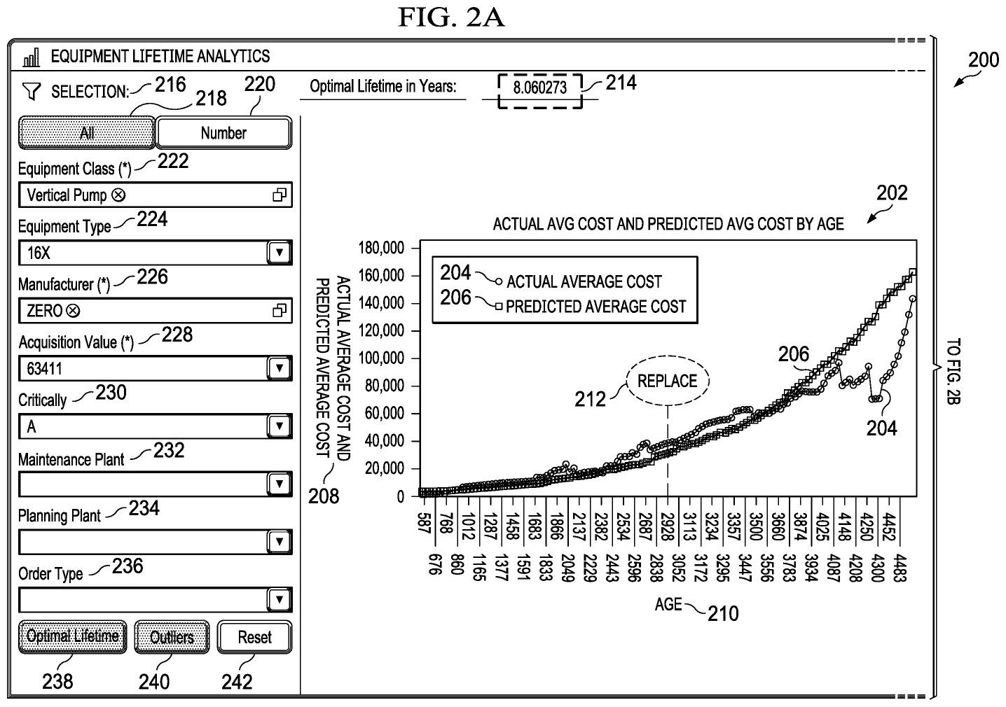

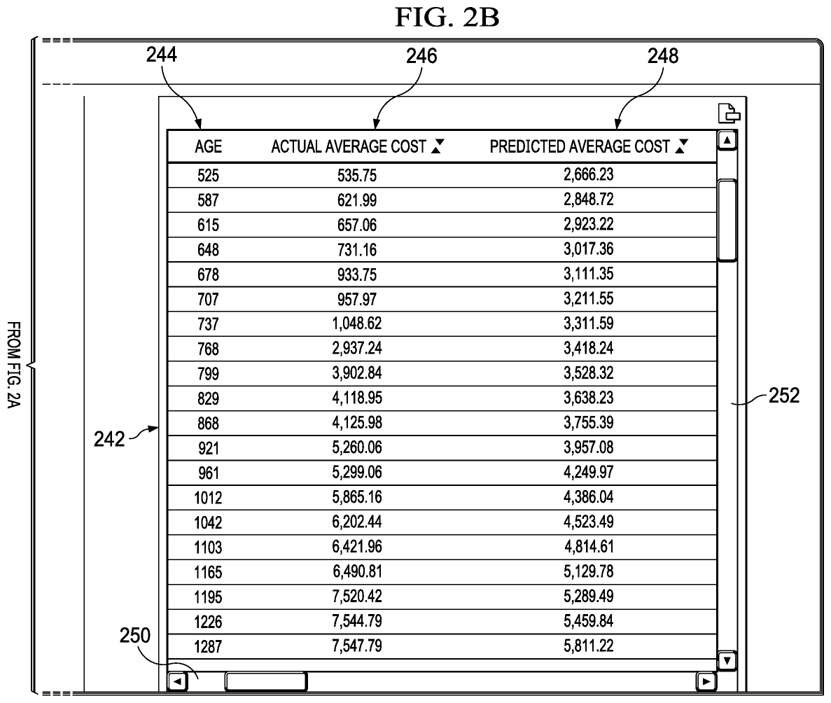

FIGS. 2A-2B collectively show a screen print of an example of a graphical user interface (GUI) 200 for presenting cost information, according to some implementations of the present disclosure. The GUI 200 can be an equipment lifeline analytics interface, for example. The GUI 200 can serve as a visualization tool that helps users to better understand and interpret results of executing the cost model. The GUI 200 includes a timeline on which plots can be used to highlight an estimated optimal lifetime of a piece of equipment relative to a predicted average maintenance cost for that type of equipment. The predicted average maintenance cost is produced by a cost model and follows an actual average maintenance cost function. A key piece of information displayed by the GUI 200 is an optimal lifetime 214 (for example, presented in years), which is a recommended best time to replace the selected type of equipment. The optimal lifetime 214 can also be referred to as Beyond Economic Repair (BER).

The cost model can be used to answer various cost-related questions such as “What pieces of equipment have passed their expected lifetime?” and “What pieces of equipment should be replaced in order to be cost-effective?” A list of pieces of equipment can be generated that identifies specific pieces of equipment that have been deployed and have passed their expected lifetimes.

The process of identifying specific pieces of equipment that should be replaced can be filtered or narrowed based on various selection criteria, such as type of equipment, manufacturer, criticality, and specific plant(s). For example, a user can specify specific plants in which pieces of equipment of Equipment Type X have been installed. The GUI 200 can also provide the option of entering a unique equipment number, such as a registration number. When the cost model is run, a regression model can be built that predicts the expected cumulative maintenance cost (for example, since the equipment's startup date) as a function of the age of the equipment.

Because the cost model can focus on considering the age of the equipment, different types of equipment need not be installed on the same date in order for the cost model to operate. A combination of a regression model (for example, produced by the cost model) and the acquisition value of the piece of equipment can then be used to optimize the TCO. The GUI 200 can make it easier (and more obvious) for a user to understand the TCO by showing that the maintenance costs grow exponentially toward the end of a piece of equipment's useful lifetime. The GUI 200 can also show that, during periods of time when the shape of the maintenance cost plot is generally horizontal, a decision to keep and maintain a piece of equipment is likely to be economically more cost-effective than replacing the piece of equipment.

Graph 202 shows two average (AVG) cost functions, represented by plots 204 and 206, used to predict the optimal lifetime of a piece of equipment. Plot 204 represents the actual average maintenance cost of the equipment as a function of age of the equipment in days. Plot 206 represents the average maintenance cost of the equipment that the cost model predicts at any given age. The y-axis 208 of the graph represents the average cost that can be determined using the dataset versus the AVG cost that the model predicts at each given age. Age axis 210 is the age of the equipment (for example, days since the startup date).

The graph 202 can be used by users to view the results of the performance of the model. If the two functions represented by the plots 204 and 206 follow the same pattern, then the result of the model is said to be reliable.

Replacement age 212 is the optimal lifetime/age of the equipment in days, specifically the age at which the equipment should be replaced and no longer used. The optimal lifetime 214 is the optimal lifetime/age of the equipment, for example, calculated in years. The years units are used because it is more meaningful and easier to interpret FIGS. 2A-2B in years rather than days.

The GUI 200 includes a selection section 216 that can be used by users to narrow down the selection of equipment to a group of equipment based on different characteristics. An “All” control 218 can allow the user to select a group of equipment. A “Number” control 200 can allow the user to drill down to a single piece of equipment (for example, by serial number).

Fields 222, 224, 226, and 228 can be required input fields. A drop-down list 222 can be used to select a specific class of equipment (for example, vertical pumps), where the equipment class can refer to a group of equipment sharing particular features, for example. Using this field, the user can logically complete the selection of equipment according to various criteria. Using this type of classification, the user can create a hierarchically-structured classification to easily find existing special classes, for example, starting from a superior class. A drop-down list 224 can be used to select the type of equipment (for example, a specific named type of a vertical pump) that is associated with the class of equipment chosen in the drop-down list 222. Drop-down list 226 can be used to select the manufacturer. Input field 228 can be used to enter the acquisition value.

Optional input fields that can be used to further narrow down the selection can include fields 230, 232, 234, and 236. Drop-down list 230 can be used to select critically of the equipment. Drop-down list 232 can be used to select the maintenance plant. Drop-down list 234 can be used to select the planning plant. Drop-down list 236 can be used to select the order type.

Various actions are available through the GUI 200 after the selection criteria has been specified. Using an optimal lifetime control 238, the user can trigger calculations used to estimate the optimal lifetime for the group of equipment that share the same characteristics chosen using fields in the selection section 216. Using an outliers control 240, the user can trigger the calculation (or determination) of outliers, identifying individual pieces of equipment have any maintenance cost significantly larger than a usual range for the rest of the equipment. A reset button 242 can be used to clear the selection criteria, including fields 222 through 236, for example.

A table 242 is displayed that includes data corresponding to the plots 204 and 206. For example, the table 242 can show the value of AVG maintenance for the two functions in the graph. The information can be used to interpret each point on the plots 204 and 206. An age 246 can identify the age of the equipment, for example, in days, corresponding to a value of the x-axis of the graph. An actual AVG maintenance cost 246 of the equipment can identify the value of each data point for the function drawn for the plot 204. A predicted AVG maintenance cost 248 of the equipment can identify the value of each data point for the function drawn for the plot 206. A horizontal scroll bar 250 can allow horizontal (left-to-right) scrolling of the window in which information of the table 242 is presented. A vertical scroll bar 252 can allow vertical scrolling of the table 242.

In some implementations, the system that executes the cost model and provides the GUI 200 can include multiple components. For example, the system can include a data collection module, a data pre-processing module, a predictive modeling module, and a front-end application module. Users can interact with the system through the GUI 200. The GUI 200 can be client application that runs, for example, on a client device such as a laptop or a mobile device. Processing and modeling can be run on a server side, with selections received on a client side, results determined on a server side, and results returned back to the client side. The processing and modeling can be performed using application code that performs cumulative cost calculations.

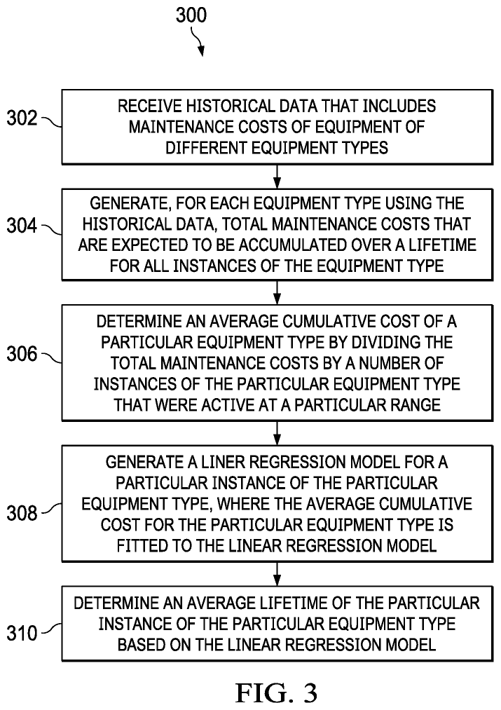

FIG. 3 is a flowchart of an example of a method 300 for determining the average lifetime of a particular instance of a particular equipment type, according to some implementations of the present disclosure. For clarity of presentation, the description that follows generally describes method 300 in the context of the other figures in this description. However, it will be understood that method 300 can be performed, for example, by any suitable system, environment, software, and hardware, or a combination of systems, environments, software, and hardware, as appropriate. In some implementations, various steps of method 300 can be run in parallel, in combination, in loops, or in any order.

At 302, historical data is received that includes maintenance costs of equipment of different equipment types. For example, a server system that serves the GUI 200 can access a database of equipment acquisition and maintenance records for all types of equipment at a facility. The information can include, for example, maintenance costs of different types of equipment having wide ranges of acquisition dates, acquisition costs, and maintenance records. From 302, method 300 proceeds to 304.

At 304, the historical data is used to generate, for each equipment type, total maintenance costs that are expected to be accumulated over a lifetime for all instances of the equipment type. For example, using cost records from initial purchase throughout maintenance over time of each instance of equipment of each type, averages can be determined. In some implementations, for each equipment type, ages of all instances of the equipment type can be normalized (or standardized) based on startup dates of all the instances of the equipment type as a first data point (for example, at which an age for the instance is zero). From 304, method 300 proceeds to 306.

At 306, an average cumulative cost of a particular equipment type is determined by dividing the total maintenance costs by a number of instances of the particular equipment type that were active at a given age. In some implementations, outliers can be removed from the averaging process in order to eliminate, for example, defective equipment that failed significantly before or after a predetermined range. From 306, method 300 proceeds to 308.

At 308, a linear regression model is generated for a particular instance of the particular equipment type. The average cumulative cost for the particular equipment type can be fitted to the linear regression model. From 308, method 300 proceeds to 310.

At 310, an average lifetime of the particular instance of the particular equipment type is determined based on the linear regression model. As an example, the average lifetime (also referred to as beyond economic repair) of equipment can be predicted based on the cumulative maintenance cost. The average lifetime can be based, for example, on a purchase cost of new equipment plus costs for shipping, installation, disposal of old equipment, and other up-front costs. After 310, method 300 can stop.

In some implementations, method 300 further includes presenting the average lifetime of the particular instance of the particular equipment type in a graphical user interface presented to a user. For example, the optimal lifetime 214 (a recommended best time to replace the selected type of equipment) can be displayed in the GUI 200. As shown in FIGS. 2A-2B, the GUI 200 can present the average cumulative cost plot 204 and the actual cumulative cost plot 206.

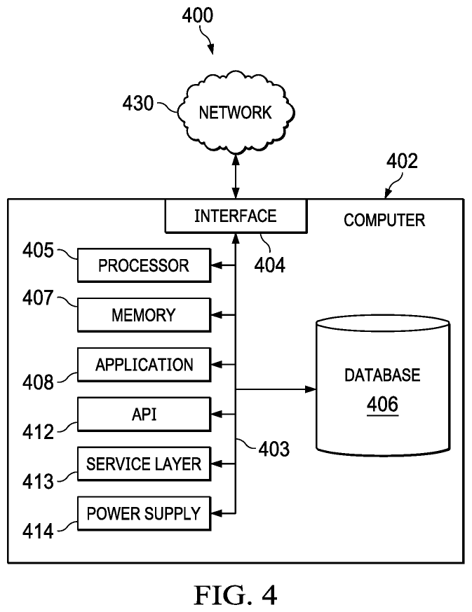

FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a top level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both) over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

For example, in a first implementation, a computer-implemented method includes the following. Historical data is received that includes maintenance costs of equipment of different equipment types. The historical data is used to generate, for each equipment type, total maintenance costs that are expected to be accumulated over a lifetime for all instances of the equipment type. An average cumulative cost of a particular equipment type is determined by dividing the total maintenance costs by a number of instances of the particular equipment type that were active at a particular age. A linear regression model is generated for a particular instance of the particular equipment type. The average cumulative cost for the particular equipment type is fitted to the linear regression model. An average lifetime of the particular instance of the particular equipment type is determined based on the linear regression model.

The foregoing and other described implementations can each, optionally, include one or more of the following features:

A first feature, combinable with any of the following features, the method further including normalizing, for each equipment type, ages of all instances of the equipment type based on startup dates of all the instances of the equipment type as a first data point at which an age is zero.

A second feature, combinable with any of the previous or following features, the method further including determining a startup date of a piece of equipment based on a first maintenance date of the piece of equipment.

A third feature, combinable with any of the previous or following features, the method further including presenting the average lifetime the particular instance of the particular equipment type in a graphical user interface presented to a user.

A fourth feature, combinable with any of the previous or following features, the method further including presenting, in a graphical user interface, an average cumulative cost curve and an actual cumulative cost curve; where the average cumulative cost curve represents average cumulative costs of instances of the particular equipment type, and where the actual cumulative cost curve represents cumulative costs of the particular instance of the particular equipment type.

A fifth feature, combinable with any of the previous or following features, the method further including: presenting, in the graphical user interface, controls for selecting the particular instance of the particular equipment type; selecting the particular instance of the particular equipment type based on user selections of the controls; and displaying, in the graphical user interface, the average cumulative cost curve and the actual cumulative cost curve for the particular instance of the particular equipment type.

A sixth feature, combinable with any of the previous or following features, where the controls include: a drop-down list for selecting a specific class of equipment; a drop-down list for selecting the particular equipment type; a drop-down list for selecting an equipment manufacturer; an input field for acquisition value; a drop-down list for selecting a critically of instances of equipment; a drop-down list for selecting a maintenance plant; a drop-down list for selecting a planning plant; and a drop-down list for selecting an order type.

A seventh feature, combinable with any of the previous or following features, the controls further include: an optimal lifetime control for triggering calculations used to estimate an optimal lifetime for a group of equipment matching user selections of the controls; and an outliers control for triggering a determination of outliers, including individual pieces of equipment having maintenance costs higher than average for a given type of equipment.

In a second implementation, a non-transitory, computer-readable medium stores one or more instructions executable by a computer system to perform operations including the following. Historical data is received that includes maintenance costs of equipment of different equipment types. The historical data is used to generate, for each equipment type, total maintenance costs that are expected to be accumulated over a lifetime for all instances of the equipment type. An average cumulative cost of a particular equipment type is determined by dividing the total maintenance costs by a number of instances of the particular equipment type that were active at a particular age. A linear regression model is generated for a particular instance of the particular equipment type. The average cumulative cost for the particular equipment type is fitted to the linear regression model. An average lifetime of the particular instance of the particular equipment type is determined based on the linear regression model.

The foregoing and other described implementations can each, optionally, include one or more of the following features:

A first feature, combinable with any of the following features, the operations further including normalizing, for each equipment type, ages of all instances of the equipment type based on startup dates of all the instances of the equipment type as a first data point at which an age is zero.

A second feature, combinable with any of the previous or following features, the operations further including determining a startup date of a piece of equipment based on a first maintenance date of the piece of equipment.

A third feature, combinable with any of the previous or following features, the operations further including presenting the average lifetime the particular instance of the particular equipment type in a graphical user interface presented to a user.

A fourth feature, combinable with any of the previous or following features, the operations further including presenting, in a graphical user interface, an average cumulative cost curve and an actual cumulative cost curve; where the average cumulative cost curve represents average cumulative costs of instances of the particular equipment type, and where the actual cumulative cost curve represents cumulative costs of the particular instance of the particular equipment type.

A fifth feature, combinable with any of the previous or following features, the operations further including: presenting, in the graphical user interface, controls for selecting the particular instance of the particular equipment type; selecting the particular instance of the particular equipment type based on user selections of the controls; and displaying, in the graphical user interface, the average cumulative cost curve and the actual cumulative cost curve for the particular instance of the particular equipment type.

A sixth feature, combinable with any of the previous or following features, where the controls include: a drop-down list for selecting a specific class of equipment; a drop-down list for selecting the particular equipment type; a drop-down list for selecting an equipment manufacturer; an input field for acquisition value; a drop-down list for selecting a critically of instances of equipment; a drop-down list for selecting a maintenance plant; a drop-down list for selecting a planning plant; and a drop-down list for selecting an order type.

A seventh feature, combinable with any of the previous or following features, the controls further include: an optimal lifetime control for triggering calculations used to estimate an optimal lifetime for a group of equipment matching user selections of the controls; and an outliers control for triggering a determination of outliers, including individual pieces of equipment having maintenance costs higher than average for a given type of equipment.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Historical data is received that includes maintenance costs of equipment of different equipment types. The historical data is used to generate, for each equipment type, total maintenance costs that are expected to be accumulated over a lifetime for all instances of the equipment type. An average cumulative cost of a particular equipment type is determined by dividing the total maintenance costs by a number of instances of the particular equipment type that were active at a particular age. A linear regression model is generated for a particular instance of the particular equipment type. The average cumulative cost for the particular equipment type is fitted to the linear regression model. An average lifetime of the particular instance of the particular equipment type is determined based on the linear regression model.

The foregoing and other described implementations can each, optionally, include one or more of the following features:

A first feature, combinable with any of the following features, the operations further including normalizing, for each equipment type, ages of all instances of the equipment type based on startup dates of all the instances of the equipment type as a first data point at which an age is zero.

A second feature, combinable with any of the previous or following features, the operations further including determining a startup date of a piece of equipment based on a first maintenance date of the piece of equipment.

A third feature, combinable with any of the previous or following features, the operations further including presenting the average lifetime the particular instance of the particular equipment type in a graphical user interface presented to a user.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving historical data that includes maintenance costs of equipment of different equipment types;
generating, for each equipment type using the historical data, total maintenance costs that are expected to be accumulated over a lifetime for all instances of the equipment type;
determining an average cumulative cost of a particular equipment type by dividing the total maintenance costs by a number of instances of the particular equipment type that were active at a given age;
generating a linear regression model for a particular instance of the particular equipment type, wherein the average cumulative cost for the particular equipment type is fitted to the linear regression model; and
determining an average lifetime of the particular instance of the particular equipment type based on the linear regression model.

2. The computer-implemented method of claim 1, further comprising normalizing, for each equipment type, ages of all instances of the equipment type based on startup dates of all the instances of the equipment type as a first data point at which an age is zero.

3. The computer-implemented method of claim 2, further comprising determining a startup date of a piece of equipment based on a first maintenance date of the piece of equipment.

4. The computer-implemented method of claim 1, further comprising presenting the average lifetime the particular instance of the particular equipment type in a graphical user interface presented to a user.

5. The computer-implemented method of claim 1, further comprising presenting, in a graphical user interface, an average cumulative cost curve and an actual cumulative cost curve, wherein the average cumulative cost curve represents average cumulative costs of instances of the particular equipment type, and wherein the actual cumulative cost curve represents cumulative costs of the particular instance of the particular equipment type.

6. The computer-implemented method of claim 5, further comprising:
presenting, in the graphical user interface, controls for selecting the particular instance of the particular equipment type;
selecting the particular instance of the particular equipment type based on user selections of the controls; and
displaying, in the graphical user interface, the average cumulative cost curve and the actual cumulative cost curve for the particular instance of the particular equipment type.

7. The computer-implemented method of claim 6, wherein the controls include:
a drop-down list for selecting a specific class of equipment;
a drop-down list for selecting the particular equipment type;
a drop-down list for selecting an equipment manufacturer;
an input field for acquisition value;
a drop-down list for selecting a critically of instances of equipment;
a drop-down list for selecting a maintenance plant;
a drop-down list for selecting a planning plant; and
a drop-down list for selecting an order type.

8. The computer-implemented method of claim 7, wherein the controls further include:
an optimal lifetime control for triggering calculations used to estimate an optimal lifetime for a group of equipment matching user selections of the controls; and
an outliers control for triggering a determination of outliers, including individual pieces of equipment having maintenance costs higher than average for a given type of equipment.

9. A non-transitory, computer-readable medium storing one or more instructions executable by a computer system to perform operations comprising:
receiving historical data that includes maintenance costs of equipment of different equipment types;
generating, for each equipment type using the historical data, total maintenance costs that are expected to be accumulated over a lifetime for all instances of the equipment type;
determining an average cumulative cost of a particular equipment type by dividing the total maintenance costs by a number of instances of the particular equipment type that were active at a given age;
generating a linear regression model for a particular instance of the particular equipment type, wherein the average cumulative cost for the particular equipment type is fitted to the linear regression model; and
determining an average lifetime of the particular instance of the particular equipment type based on the linear regression model.

10. The non-transitory, computer-readable medium of claim 9, the operations further comprising normalizing, for each equipment type, ages of all instances of the equipment type based on startup dates of all the instances of the equipment type as a first data point at which an age is zero.

11. The non-transitory, computer-readable medium of claim 10, the operations further comprising determining a startup date of a piece of equipment based on a first maintenance date of the piece of equipment.

12. The non-transitory, computer-readable medium of claim 9, the operations further comprising presenting the average lifetime the particular instance of the particular equipment type in a graphical user interface presented to a user.

13. The non-transitory, computer-readable medium of claim 9, the operations further comprising presenting, in a graphical user interface, an average cumulative cost curve and an actual cumulative cost curve, wherein the average cumulative cost curve represents average cumulative costs of instances of the particular equipment type, and wherein the actual cumulative cost curve represents cumulative costs of the particular instance of the particular equipment type.

14. The non-transitory, computer-readable medium of claim 13, the operations further comprising:
presenting, in the graphical user interface, controls for selecting the particular instance of the particular equipment type;
selecting the particular instance of the particular equipment type based on user selections of the controls; and
displaying, in the graphical user interface, the average cumulative cost curve and the actual cumulative cost curve for the particular instance of the particular equipment type.

15. The non-transitory, computer-readable medium of claim 14, wherein the controls include:
a drop-down list for selecting a specific class of equipment;
a drop-down list for selecting the particular equipment type;
a drop-down list for selecting an equipment manufacturer;
an input field for acquisition value;
a drop-down list for selecting a critically of instances of equipment;
a drop-down list for selecting a maintenance plant;
a drop-down list for selecting a planning plant; and
a drop-down list for selecting an order type.

16. The non-transitory, computer-readable medium of claim 15, wherein the controls further include:
an optimal lifetime control for triggering calculations used to estimate an optimal lifetime for a group of equipment matching user selections of the controls; and
an outliers control for triggering a determination of outliers, including individual pieces of equipment having maintenance costs higher than average for a given type of equipment.

17. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving historical data that includes maintenance costs of equipment of different equipment types;
generating, for each equipment type using the historical data, total maintenance costs that are expected to be accumulated over a lifetime for all instances of the equipment type;
determining an average cumulative cost of a particular equipment type by dividing the total maintenance costs by a number of instances of the particular equipment type that were active at a given age;
generating a linear regression model for a particular instance of the particular equipment type, wherein the average cumulative cost for the particular equipment type is fitted to the linear regression model; and
determining an average lifetime of the particular instance of the particular equipment type based on the linear regression model.

18. The computer-implemented system of claim 17, the operations further comprising normalizing, for each equipment type, ages of all instances of the equipment type based on startup dates of all the instances of the equipment type as a first data point at which an age is zero.

19. The computer-implemented system of claim 18, the operations further comprising determining a startup date of a piece of equipment based on a first maintenance date of the piece of equipment.

20. The computer-implemented system of claim 17, the operations further comprising presenting the average lifetime the particular instance of the particular equipment type in a graphical user interface presented to a user.
